(19) United States
(12) Patent Application Publication
(10) Pub. No.: US 2023/0274415 A1
(43) Pub. Date: Aug. 31, 2023

(54) CLUSTER-BASED AND AUTONOMOUS FINDING OF REFERENCE INFORMATION

(71) Applicant: LEAN AI TECHNOLOGIES LTD., Tel Aviv (IL)

(72) Inventors: Tom TABAK, Tel Aviv (IL); Zvi Lapp, Modi'in Maccabim-Re'ut (IL)

(73) Assignee: LEAN AI TECHNOLOGIES LTD., Tel Aviv (IL)

(21) Appl. No.: 18/176,403

(22) Filed: Feb. 28, 2023

Related U.S. Application Data
(60) Provisional application No. 63/268,698, filed on Feb. 28, 2022.

(51) Int. Cl. G06T 7/00; G06V 10/82

(52) U.S. Cl. CPC G06T 7/001; G06V 10/82; G06T 2207/20081

(57) ABSTRACT

A method for unsupervised learning based anomaly detection of manufactured items, the method may include: obtaining multiple item pixels of an item; determining item features of the item, based on the multiple item pixels and by a non-item specific neural network, the non-item specific neural network is pre-trained to perform feature extraction of objects, at least some of the objects differ from the item; determining, based on the item features, a pixel score for item pixels of the multiple item pixels; for each of the item pixels, calculating a distance between the pixel score and reference pixel-wise distribution information; and for each of the item pixels, determining whether the item pixel is an anomaly pixel based on a comparison between the pixel score and a pixel-wise threshold.

### BACKGROUND

Defect detection is a process that involve acquiring images of evaluated objects and processing the images to detect defects. A common method for defect detection include comparing an image of an evaluated object to an image of a reference object.

It may be beneficial to compare the evaluated object to a reference object that is defect free—but generating an image of a defect free reference object may also be time and resource consuming. Comparing the inspected object to an arbitrary reference object may provide ambiguous results—as a different between the evaluated object and the reference object may result from defects of the evaluated object or the reference object.

There is a growing need to provide a cost-effective method for cluster-based and autonomous finding of reference information.

### SUMMARY

There is provided a method, a system and/or a non-transitory computer readable medium for cluster-based and autonomous finding of reference information.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the units may be implemented in hardware and/or code, instructions and/or commands stored in a non-transitory computer readable medium, may be included in a vehicle, outside a vehicle, in a mobile device, in a server, and the like.

The vehicle may be any type of vehicle that a ground transportation vehicle, an airborne vehicle, and a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a method, system and a non-transitory computer readable medium for

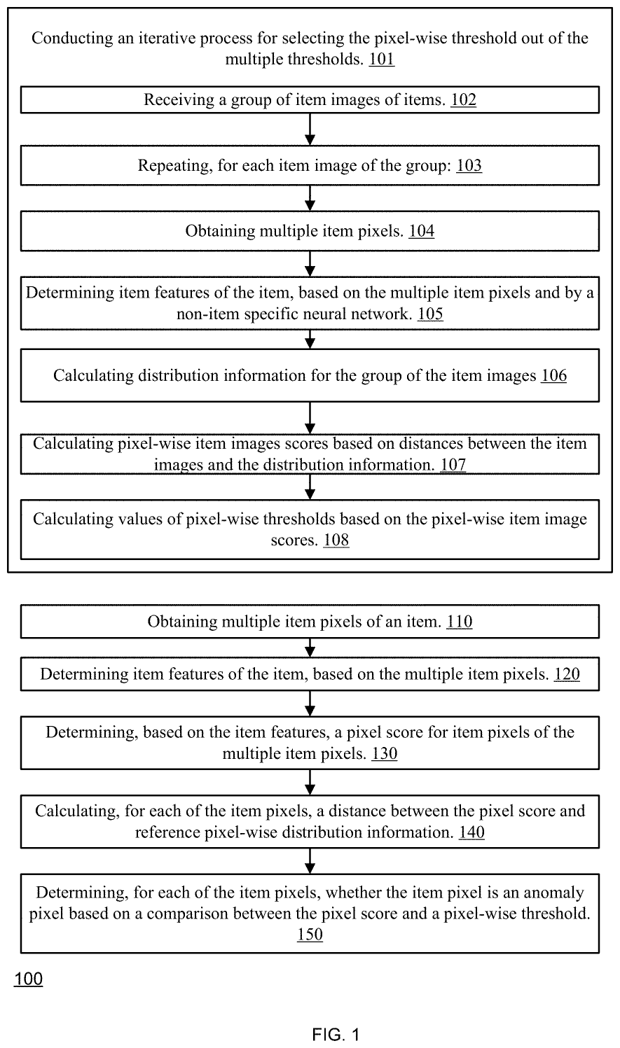

FIG. 1 illustrates method 100 for unsupervised learning based anomaly detection of manufactured items.

Method 100 may start by step 110 of obtaining multiple item pixels of an item.

Step 110 may include receiving an image and generating a cropped image that comprises the multiple item pixels.

Step 110 may be followed by step 120 of determining item features of the item, based on the multiple item pixels.

The item features may be determined by a non-item specific neural network, the non-item specific neural network is pre-trained to perform feature extraction of objects, at least some of the objects differ from the item.

Step 120 may include, for example, running an inference on the cropped using a generic, industry standard state-of-the-art pre-trained neural network (such but not limited to wide ResNet50 pretrained on ImageNet).

Step 120 may be followed by step 130 of determining, based on the item features, a pixel score for item pixels of the multiple item pixels.

Step 130 may be followed by step 140 of calculating, for each of the item pixels, a distance between the pixel score and reference pixel-wise distribution information.

The reference pixel-wise distribution information may be a part of reference information that includes a reference mean matrix and reference covariance matrix.

Step 140 may be followed by step 150 of determining, for each of the item pixels, whether the item pixel is an anomaly pixel based on a comparison between the pixel score and a pixel-wise threshold.

The one or more anomaly detection parameters may include false positives, true positives, true positives and false negatives.

The one or more anomaly detection parameters may include image level detection parameters and anomaly level detection parameters.

The method may include responding to the outcome of step 150. This may include, for example,

Step 150 may be followed by responding to the outcome of step 150. This may include at least one of:
a. Generating an anomaly alert indicative of the anomaly.
b. Performing an inspection of other items (for example other manufactured items that should—in an ideal manufacturing process—be identical).
c. Determining a defects in a manufacturing process (of the manufactured items).
d. Finding desired parameters of the manufacturing process of the manufactured items.
e. Requesting or instructing a manufacturing machine to alter the manufacturing process of the manufactured items.
f. Storing the information found in step 150.
g. Sending the information found in step 150.
h. Transmitting the information found in step 150 to defect detection systems and/or other inspection systems for use in future inspections and/or defect detection processes.

A combination of steps 120, 130 and 140 may include, for example (the size of any dimension of any matrix can be different from those illustrated below:

Calculating a pixel wise mean value of the feature map for every pixel i, j as well as a covariance_matrix and mean_matrix—which together shall here on forth will be referred to as the distribution. Using the steps below:
a. Initialize orthogonal_matrix of shape [1024, 300] (features extracted dimension, parameter k) input image of shape [3, 178, 464].
b. Use black box neural network image feature extractor on crop to get feature_map [1024, 12, 29]
c. Perform matrix multiplication between orthogonal matrix and feature_map to get output of shape [12, 29, 300] to get orthogonal_feature_map.
d. Perform matrix multiplication between the orthogonal_feature_map and the orthoginal_feature_map get output_cov matrix shape of [12, 29, 300, 300].
e. Perform matrix transpose to orthoginal_feature_map to get output_mean matrix shape of [300, 12, 29].
f. Repeat steps b-e across all data and perform mean across all output_cov tensors to produce covariance_matrix of shape [12, 29, 300, 300] and output_mean tensors to produce mean_matrix of shape [300, 12, 29].

Calculating the mahalanobis distance (distance between distribution and point) between each pixel of the corresponding pixel's distribution to get the pixel's score using the equation using the following steps:
a. Use black box neural network image feature extractor on crop to get feature_map [1024, 12, 29]
b. Perform matrix multiplication with orthogonal_matrix and feature_map and then transpose to get output of shape [300, 12, 29] to get orthogonal_feature_map.
c. Calculate difference between orthogonal_feature_map and mean_matrix to get matrix of output [300, 12, 29] to get the difference_matrix.
d. Perform matrix multiplication between difference_matrix, covariance_matrix, difference_matrix to get output_matrix of shape [1, 12, 29].
e. Perform the square root on the absolute values of output_matrix to get distance_score of [1, 12, 29].
f. Interpolate the distance_score to shape [1, 178, 464] using the nearest neighbor interpolation method.

The pixel-wise threshold may be selected out of multiple thresholds by conducting an iterative process and are based on one or more anomaly detection parameters.

The iterative process may include searching over a range of thresholds (between the minimum distance score pixel and maximum score pixel) a best performing threshold.

The threshold shall be used as a decision boundary by which pixels with values above the threshold are suspected defects where those below are not suspected defects.

The best performing threshold is defined by the threshold that returns a combination of the highest image level detection rate, lowest image level false alarm rate, highest defect level detection rate and lowest defect level false alarm rate. Where detection rates are calculated by Number of True Positives divided by the sum of the Number of True Positives and False Negatives and False Alarm rate is defined by the number of False Positives divided by the sum of Number of False Positives and True Negatives. The priority of these aforementioned metrics is in descending order of the listings.

Method 100 may include step 101 of conducting the iterative process for selecting the pixel-wise threshold out of the multiple thresholds.

Step 101 may include steps 102, 103, 104, 105, 106, 107 and 108.

Step 102 may include receiving a group of item images of items.

Step 103 may include repeating, for each item image of the group:
a. Step 104 of obtaining multiple item pixels.
b. Step 105 of determining item features of the item, based on the multiple item pixels and by a non-item specific neural network. The non-item specific neural network may be, for example, wide ResNet50 that may be pretrained on ImageNet.
c. Step 106 of calculating distribution information for the group of the item images.
d. Step 107 of calculating pixel-wise item images scores based on distances between the item images and the distribution information.
e. Step 108 of calculating values of pixel-wise thresholds based on the pixel-wise item image scores.

The distribution information calculated during step 106 may include group covariance information and mean value information.

The group covariance information may be a covariance matrix and the mean value information may be a group mean value matrix.

Step 108 may include calculating a value of a pixel-wise threshold in an iterative manner that includes calculating values of one or more anomaly detection parameters under different candidates of the values of pixel-wise thresholds.

Method 100 may be executed by a computerized system that may include one or more processors, wherein each processor is a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. The computerized system may include one or more hardware memory units and/or one or more communication units, and the like.

Method 100 provides an improvement in computer science—as it is effective—may be executed without prior knowledge and/or without historic bias or errors. The method is accurate. The method saves storage and/or computational resources due to its compactness and its simplicity.

There may be provided a non-transitory computer readable medium for unsupervised learning based anomaly detection of manufactured items, the non-transitory computer readable medium stores instructions for: obtaining multiple item pixels of an item; determining item features of the item, based on the multiple item pixels and by a non-item specific neural network, the non-item specific neural network may be pre-trained to perform feature extraction of objects, at least some of the objects differ from the item; determining, based on the item features, a pixel score for item pixels of the multiple item pixels; for each of the item pixels, calculating a distance between the pixel score and reference pixel-wise distribution information; and for each of the item pixels, determining whether the item pixel may be an anomaly pixel based on a comparison between the pixel score and a pixel-wise threshold.

The obtaining of the multiple item pixels may include receiving an image and generating a cropped image that may include the multiple item pixels.

The distance may be a Mahalanobis distance.

The reference pixel-wise distribution information belongs may be a part of reference information that may include a reference mean matrix and reference covariance matrix.

The pixel-wise threshold may be selected out of multiple thresholds by conducting an iterative process and may be based on one or more anomaly detection parameters.

The one or more anomaly detection parameters may include false positives, true positives, true positives and false negatives.

The one or more anomaly detection parameters may include image level detection parameters and anomaly level detection parameters.

The non-transitory computer readable medium may store instructions for receiving a group of item images of items; for each item image repeating the steps of: obtaining multiple item pixels; determining item features of the item, based on the multiple item pixels and by a non-item specific neural network; calculating distribution information for the group of the item images; calculating pixel-wise item images scores based on distances between the item images and the distribution information; and calculating values of pixel-wise thresholds based on the pixel-wise item image scores.

The distribution information may include group covariance information and mean value information.

The non-transitory computer readable medium may store instructions for calculating a value of a pixel-wise threshold in an iterative manner that may include calculating values of one or more anomaly detection parameters under different candidates of the values of pixel-wise thresholds.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for unsupervised learning based anomaly detection of manufactured items, the method comprises:
obtaining multiple item pixels of an item;
determining item features of the item, based on the multiple item pixels and by a non-item specific neural network, the non-item specific neural network is pre-trained to perform feature extraction of objects, at least some of the objects differ from the item;
determining, based on the item features, a pixel score for item pixels of the multiple item pixels;
for each of the item pixels, calculating a distance between the pixel score and reference pixel-wise distribution information; and
for each of the item pixels, determining whether the item pixel is an anomaly pixel based on a comparison between the pixel score and a pixel-wise threshold.

2. The method according to claim 1 wherein the obtaining of the multiple item pixels comprises receiving an image and generating a cropped image that comprises the multiple item pixels.

3. The method according to claim 1 wherein the distance is a Mahalanobis distance.

4. The method according to claim 1 wherein the reference pixel-wise distribution information belongs is a part of reference information that comprises a reference mean matrix and reference covariance matrix.

5. The method according to claim 1 wherein the pixel-wise threshold is selected out of multiple thresholds by conducting an iterative process and are based on one or more anomaly detection parameters.

6. The method according to claim 5 wherein the one or more anomaly detection parameters comprise false positives, true positives, true positives and false negatives.

7. The method according to claim 5 wherein the one or more anomaly detection parameters comprise image level detection parameters and anomaly level detection parameters.

8. The method according to claim 1 comprising:
receiving a group of item images of items;
for each item image repeating the steps of:
obtaining multiple item pixels;
determining item features of the item, based on the multiple item pixels and by a non-item specific neural network;
calculating distribution information for the group of the item images;
calculating pixel-wise item images scores based on distances between the item images and the distribution information; and
calculating values of pixel-wise thresholds based on the pixel-wise item image scores.

9. The method according to claim 8 wherein the distribution information comprises group covariance information and mean value information.

10. The method according to claim 9 wherein the group covariance information is a covariance matrix and the mean value information is a group mean value matrix.

11. The method according to claim 8 comprising calculating a value of a pixel-wise threshold in an iterative manner that comprises calculating values of one or more anomaly detection parameters under different candidates of the values of pixel-wise thresholds.

12. A non-transitory computer readable medium for unsupervised learning based anomaly detection of manufactured items, the non-transitory computer readable medium stores instructions for:
obtaining multiple item pixels of an item;
determining item features of the item, based on the multiple item pixels and by a non-item specific neural network, the non-item specific neural network is pre-trained to perform feature extraction of objects, at least some of the objects differ from the item;
determining, based on the item features, a pixel score for item pixels of the multiple item pixels;
for each of the item pixels, calculating a distance between the pixel score and reference pixel-wise distribution information; and
for each of the item pixels, determining whether the item pixel is an anomaly pixel based on a comparison between the pixel score and a pixel-wise threshold.

13. The non-transitory computer readable medium according to claim 1 wherein the obtaining of the multiple item pixels comprises receiving an image and generating a cropped image that comprises the multiple item pixels.

14. The non-transitory computer readable medium according to claim 13 wherein the distance is a Mahalanobis distance.

15. The non-transitory computer readable medium according to claim 13 wherein the reference pixel-wise distribution information belongs is a part of reference information that comprises a reference mean matrix and reference covariance matrix.

16. The non-transitory computer readable medium according to claim 13 wherein the pixel-wise threshold is selected out of multiple thresholds by conducting an iterative process and are based on one or more anomaly detection parameters.

17. The non-transitory computer readable medium according to claim 16 wherein the one or more anomaly detection parameters comprise false positives, true positives, true positives and false negatives.

18. The non-transitory computer readable medium according to claim 16 wherein the one or more anomaly detection parameters comprise image level detection parameters and anomaly level detection parameters.

19. The non-transitory computer readable medium according to claim 13 that stores instructions for
receiving a group of item images of items;
for each item image repeating the steps of:
obtaining multiple item pixels;
determining item features of the item, based on the multiple item pixels and by a non-item specific neural network;
calculating distribution information for the group of the item images;
calculating pixel-wise item images scores based on distances between the item images and the distribution information; and
calculating values of pixel-wise thresholds based on the pixel-wise item image scores.

20. The non-transitory computer readable medium according to claim 19 wherein the distribution information comprises group covariance information and mean value information.
